(19) United States
(12) Patent Application Publication
(10) Pub. No.: US 2023/0194163 A1
(43) Pub. Date: Jun. 22, 2023

(54) Evaluation method and system for assessing the estimate of energy consumption per tonne in distillation processes

(71) Applicant: Jiangnan University, Wuxi (CN)

(72) Inventors: Xiaoli LUAN, Wuxi (CN); Wei XUE, Wuxi (CN); Haiying WAN, Wuxi (CN); Shunyi ZHAO, Wuxi (CN); Fei LIU, Wuxi (CN)

(21) Appl. No.: 18/070,540

(22) Filed: Nov. 29, 2022

(30) Foreign Application Priority Data
Nov. 29, 2021 (CN) 202111437283.2

(51) Int. Cl. F25J 3/04; B01D 3/14

(52) U.S. Cl. CPC F25J 3/04848; B01D 3/14; F25J 2200/02

(57) ABSTRACT

The present disclosure discloses a method for evaluating estimation accuracy of energy consumption per ton in distillation processes, and belongs to the technical field of evaluation of estimation performance of energy consumption per ton in distillation processes. The method includes building a state space model of a distillation process, determining a state estimation model, and obtaining an estimated value of energy consumption per ton in the distillation process according to the state estimation model and the state space model; obtaining an estimated value of a state variable with the optimal overall evaluation using a determined evaluation function, describing interference information making the estimated value deviate from a true value and being reflected in an observed value, and transferring the interference information from the observed value to the estimated value of the state variable to obtain an estimation accuracy of the state variable; and unitizing the interference information affecting the estimated value, and evaluating the estimation accuracy of energy consumption per ton based on the unitized interference information. The present disclosure may well reflect the deviation between the estimated value and the true value without the true value, and evaluate the same object using different estimation methods under the same architecture, so that the evaluation results may cross different estimation methods and still have practicality.

### TECHNICAL FIELD

The present disclosure relates to the technical field of evaluation of estimation performance of energy consumption per ton in distillation processes, and in particular to a method and system for evaluating estimation accuracy of energy consumption per ton in distillation processes.

### BACKGROUND

A distillation column in the petrochemical industry is irreplaceable major energy consuming equipment for the production of national strategic materials. Energy conservation of major energy consuming equipment is the key to achieving energy conservation and emission reduction in the manufacturing industry, which may not only effectively reduce industrial energy consumption, but also produce more strategic materials. However, the energy consumption per ton of a distillation column may only be obtained after a production process is finished and is difficult to be detected online. Therefore, it is particularly important to build an effective mathematical model for estimation. In recent years, estimation methods of energy consumption per ton in distillation processes emerge endlessly. But interference information, for example, which energy consumption estimation method is suitable for which working condition and which environment, and how accurate the same energy consumption estimation method is in different processes or different environments of the same process, is crucial to whether energy conservation and emission reduction can be realized. Therefore, it is of great significance to evaluate estimation accuracy of energy consumption per ton in distillation processes.

Theoretically, evaluation of the estimation accuracy of energy consumption should use the error between the estimated value and the true value of energy consumption or the error between the estimated value and the optimal estimated value of energy consumption, but it is difficult to obtain the true value and the optimal estimated value of energy consumption in practical applications. Although some research has been done on evaluation of the estimation accuracy of energy consumption, there are mainly two available systems for evaluation of the estimation accuracy of energy consumption. One system uses the estimated true value of energy consumption for evaluation by simulation software, but in fact, the true value cannot be obtained in real applications, and only some classification summaries can be made through simulation. The other system is to compare the results before and after a system is used, i.e., compare the results before and after an energy consumption estimation method is used, and use the difference to indirectly reflect the evaluation result of the estimation accuracy of energy consumption. However, when such energy consumption estimation method is used in another system, or even in different environments of the same system, the evaluation results are different, so the results obtained by comparison before and after the system is used have no generality.

Therefore, how to evaluate the estimation accuracy of energy consumption without the true value and the optimal estimated value of energy consumption is an urgent problem.

### SUMMARY

For the above reason, the technical problem to be solved by the present disclosure is to overcome the problems in the prior art and provide a method and system for evaluating estimation accuracy of energy consumption per ton in distillation processes, which can well reflect the deviation between an estimated value and a true value without the true value, and evaluate the same object using different estimation methods under the same architecture, so that the evaluation results may cross different estimation methods and still have practicality.

To solve the above technical problem, the present disclosure provides a method for evaluating estimation accuracy of energy consumption per ton in distillation processes, which includes the following steps:

building a state space model of a distillation process, obtaining a model predicted value based on the state space model, and obtaining an observed value of the distillation process;

determining a state estimation model based on the observed value and the model predicted value, and obtaining an estimated value of energy consumption per ton in the distillation process according to the state estimation model and the state space model;

obtaining an estimated value of a state variable with the optimal overall evaluation using a determined evaluation function, extracting interference information making the estimated value deviate from a true value from the observed value, and transferring the interference information from the observed value to the estimated value of the state variable to obtain an estimation accuracy of the state variable; and

unitizing the interference information affecting the estimated value, and evaluating the estimation accuracy of energy consumption per ton based on the unitized interference information.

In one example of the present disclosure, the state estimation model is determined based on the observed value and the model predicted value as follows:

\hat{x}ₙ=\hat{x}ₙ⁻+Kₙ(yₙ−Cₙ\hat{x}ₙ⁻)

where n is the time, \hat{x}ₙ⁻ is the model predicted value, yₙ is the observed value, \dot{x}ₙ is an estimated value of a state variable, and Kₙ is an estimated gain.

In one example of the present disclosure, a method for obtaining the estimated value of energy consumption per ton in the distillation process according to the state estimation model and the state space model includes:

conducting state estimation at a certain time according to the state estimation model and the state space model to obtain a state estimated gain and an estimated value of the state variable at a current time; and

obtaining an estimated value of energy consumption per ton based on the estimated value of the state variable.

In one example of the present disclosure, a method for obtaining the estimated value of the state variable with the optimal overall evaluation using the determined evaluation function includes:

determining a mathematical expression of the evaluation function to be F(\dot{x}ₙ⁻, yₙ) , and obtaining the estimated value

$${\dot{x}}_{n} = arg {min}_{{x}_{n}} \frac{1}{T} {\sum }_{i = 1}^{T} F ( {\dot{x}}_{n}^{-} , {y}_{n} )$$

of the state variable with the optimal overall evaluation by the evaluation function, where T is the duration from an initial time to the current time.

In one example of the present disclosure, a method for extracting the interference information making the estimated value deviate from the true value from the observed value, and transferring the interference information from the observed value to the estimated value of the state variable to obtain the estimation accuracy of the state variable includes:

representing the interference information making the estimated value deviate from the true value and being reflected in the observed value as yₙ^{δ}, where yₙ^{δ} [symbol] yₙ+δ, and δ represents a vector with the same dimension as the observed value;

transferring the interference information from the observed value to the estimated value of the state variable by the following formula:

$${\dot{x}}_{n} ( ε , δ ) = {arg min}_{x} {\sum }_{i = 0}^{n} {F}_{n} ( {\dot{x}}_{n}^{-} , {y}_{n} ) + ε [ F ( {\dot{x}}_{n}^{-} , {y}_{n}^{δ} ) - F ( {\dot{x}}_{n}^{-} , {y}_{n} ) ]$$

where ε is a minimum and scalar, and \dot{x}ₙ(ε, δ) represents the estimated value obtained in the case of yₙ^{δ}; and

obtaining the estimation accuracy \dot{x}ₙ(ε, δ)−\dot{x}ₙ=Δ\dot{x}ₙ of the state variable based on the formula, where Δ\dot{x}ₙ is the deviation of the estimated value from the optimal estimated value.

In one example of the present disclosure, a method for unitizing the interference information affecting the estimated value includes:

calculating the partial derivative of \dot{x}ₙ(ε, δ) in the direction ε to obtain a unitized value of the interference information affecting the estimated value:

$${{{\frac{{\dot{x}}_{n} ( ε , δ )}{d ε} \vert}_{ε = 0} n = \frac{d [ {arg min}_{x} {\sum }_{i = 0}^{n} F ( {x}_{i} , {y}_{i} ) ]}{d ε} \vert}_{ε = 0} + \frac{d ε [ F ( {\dot{x}}_{n} , {y}_{n}^{δ} ) - F ( {x}_{n} , {y}_{n} ) ]}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) ,$$

where

$${ℋ}_{n} = \frac{1}{{T}_{1}} {Σ}_{i = 1}^{{T}_{1}} {∇}_{{\dot{x}}_{n - i + 1}}^{2} F ( {\dot{x}}_{n - i + 1} , {y}_{n - i + 1}^{δ} ) ;$$

when ∥δ∥→0, simplifying the unitized value of the interference information affecting the estimated value as:

$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ ;$$

and

using the estimation accuracy of the state variable, the simplified unitized value of the interference information affecting the estimated value, and Euler formula to obtain:

$$\begin{matrix}{\dot{x}}_{n} ( ε , δ ) - {\dot{x}}_{n} \approx - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \\ \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ\end{matrix} .$$

In one example of the present disclosure, a method for evaluating the estimation accuracy of energy consumption per ton based on the unitized interference information includes:

calculating the partial derivative of F(\dot{x}ₙ(ε, δ), yₙ^{δ}) in the direction δ to obtain and unitize the interference information affecting the estimated value under the vision of the evaluation function, and defining the unitized value as an influence function Lₙ with the specific form as follows:

Lₙ^{T} [symbol] ∇_{δ}F(\dot{x}ₙ(ε, δ), yₙ^{δ})^{T}|_{δ=0};

simplifying the influence function Lₙ, and substituting a result of \dot{x}ₙ(ε, δ) into the simplified influence function Lₙ by using the derivation chain rule to obtain:

$$\begin{matrix}{{L}_{n}^{T} {=}^{△} {∇}_{δ} {F ( {\dot{x}}_{n} ( ε , δ ) , {y}_{n}^{δ} )}^{T} \vert}_{δ = 0} \\ {= {∇}_{{\dot{x}}_{n}} {F ( {\dot{x}}_{n} , {y}_{n}^{δ} )}^{T} \frac{d {\dot{x}}_{n} ( ε , δ )}{d δ} \vert}_{δ = 0} \\ = - {∇}_{{\dot{x}}_{n}} {F ( {\dot{x}}_{n} , {y}_{n}^{δ} )}^{T} {ℋ}_{n}^{- 1} ( {∇}_{{y}_{n}^{δ}} {∇}_{{\dot{x}}_{n}} F ( {x}_{n} , {y}_{n}^{δ} ) )\end{matrix}$$

where ∇_{\dot{x}}_{ₙ}F(\dot{x}ₙ, yₙ^{δ}) is the first-order derivative of F(\dot{x}ₙ, yₙ^{δ}) in the direction \dot{x}ₙ, and ∇_{y}_{ₙ}_{^{δ}}∇_{\dot{x}}_{ₙ}F(\dot{x}ₙ, yₙ^{δ}) is the first-order derivative of ∇_{\dot{x}}_{ₙ}F(\dot{x}ₙ, yₙ^{δ}) in the direction yₙ^{δ}; and

obtaining an evaluation result PGₙ=fₙ(Lⁱₙ) of the estimation accuracy of energy consumption per ton based on a solution formula of the estimation accuracy of the state variable, where PGₙ represents the evaluation result of energy consumption at time n, and Lⁱₙ represents column i in row i of Lₙ^{T}.

Further, the present disclosure provides a system for evaluating estimation accuracy of energy consumption per ton in distillation processes, which includes:

a model building module, the model building module is configured to build a state space model of a distillation process, obtain a model predicted value based on the state space model, and obtain an observed value of the distillation process;

an energy consumption estimation module, the energy consumption estimation module is configured to determine a state estimation model based on the observed value and the model predicted value, and obtain an estimated value of energy consumption per ton in the distillation process according to the state estimation model and the state space model;

an estimation accuracy calculation module, the estimation accuracy calculation module is configured to obtain an estimated value of a state variable with the optimal overall evaluation using a determined evaluation function, extract interference information making the estimated value deviate from a true value from the observed value, and transfer the interference information from the observed value to the estimated value of the state variable to obtain an estimation accuracy of the state variable; and

an estimation accuracy evaluation module, the estimation accuracy evaluation module is configured to unitize the interference information affecting the estimated value, and evaluate the estimation accuracy of energy consumption per ton based on the unitized interference information.

In one example of the present disclosure, the estimation accuracy evaluation module includes an interference information quantization unit, the interference information quantization unit is configured to unitize the interference information affecting the estimated value, by a method including:

calculating the partial derivative of \dot{x}ₙ(ε, δ) in the direction ε to obtain a unitized value of the interference information affecting the estimated value:

$${{{\frac{{\dot{x}}_{n} ( ε , δ )}{d ε} \vert}_{ε = 0} n = \frac{d [ {arg min}_{x} {\sum }_{i = 0}^{n} F ( {x}_{i} , {y}_{i} ) ]}{d ε} \vert}_{ε = 0} + \frac{d ε [ F ( {\dot{x}}_{n} , {y}_{n}^{δ} ) - F ( {x}_{n} , {y}_{n} ) ]}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) ,$$

where

$${ℋ}_{n} = \frac{1}{{T}_{1}} {\sum }_{i = 1}^{{T}_{1}} {∇}_{{\dot{x}}_{n - i + 1}}^{2} F ( {\dot{x}}_{n - i + 1} , {y}_{n - i + 1}^{δ} ) ;$$

when ∥δ∥→0, simplifying the unitized value of the interference information affecting the estimated value as:

$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ ;$$

using the estimation accuracy of the state variable, the simplified unitized value of the interference information affecting the estimated value, and Euler formula to obtain:

$$\begin{matrix}{\dot{x}}_{n} ( ε , δ ) - {\dot{x}}_{n} \approx - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \\ \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ\end{matrix} .$$

In one example of the present disclosure, the estimation accuracy evaluation module includes an estimation accuracy of energy consumption per ton evaluation unit, the estimation accuracy of energy consumption per ton evaluation unit is configured to evaluate the estimation accuracy of energy consumption per ton based on the unitized interference information, by a method including:

calculating the partial derivative of F(\dot{x}ₙ(ε, δ), yₙ^{δ}) in the direction δ to obtain and unitize the interference information affecting the estimated value under the vision of the evaluation function, and defining the unitized value as an influence function Lₙ with the specific form as follows:

Lₙ^{T} [symbol] ∇_{δ}F(\dot{x}ₙ(ε, δ), yₙ^{δ})^{T}|_{δ=0};

simplifying the influence function Lₙ, and substituting a result of \dot{x}ₙ(ε, δ) into the simplified influence function Lₙ by using the derivation chain rule to obtain:

$$\begin{matrix}{{L}_{n}^{T} {=}^{△} {∇}_{δ} {F ( {\dot{x}}_{n} ( ε , δ ) , {y}_{n}^{δ} )}^{T} \vert}_{δ = 0} \\ {= {∇}_{{\dot{x}}_{n}} {F ( {\dot{x}}_{n} , {y}_{n}^{δ} )}^{T} \frac{d {\dot{x}}_{n} ( ε , δ )}{d δ} \vert}_{δ = 0} \\ = - {∇}_{{\dot{x}}_{n}} {F ( {\dot{x}}_{n} , {y}_{n}^{δ} )}^{T} {ℋ}_{n}^{- 1} ( {∇}_{{y}_{n}^{δ}} {∇}_{{\dot{x}}_{n}} F ( {x}_{n} , {y}_{n}^{δ} ) )\end{matrix}$$

where ∇_{\dot{x}}_{ₙ}F(\dot{x}ₙ, yₙ^{δ}) is the first-order derivative of F(\dot{x}ₙ, yₙ^{δ}) in the direction \dot{x}ₙ, and ∇_{y}_{ₙ}_{^{δ}}∇_{\dot{x}}_{ₙ}F(\dot{x}ₙ, yₙ^{δ}) is the first-order derivative of ∇_{\dot{x}}_{ₙ}F(\dot{x}ₙ, yₙ^{δ}) in the direction yₙ^{δ}; and

obtaining an evaluation result PGₙ=fₙ(Lⁱₙ) of the estimation accuracy of energy consumption per ton based on a solution formula of the estimation accuracy of the state variable, where PGₙ represents the evaluation result of energy consumption at time n, and Lⁱₙ represents column i in row i of Lₙ^{T}.

The above technical solution of the present disclosure has the following advantages compared with the prior art:

The present disclosure may well reflect the deviation between the estimated value and the true value without the true value, and evaluate the same object using different estimation methods under the same architecture, so that the evaluation results may cross different estimation methods and still have practicality, and also comparison of the results of evaluation methods of estimation accuracy of energy consumption per ton has practical significance.

### BRIEF DESCRIPTION OF FIGURES

To illustrate the technical solutions of the examples of the present disclosure more clearly, the accompanying drawings used in the description of the examples are briefly introduced below. Obviously, the accompanying drawings in the following description are only some examples of the present disclosure. For those of ordinary skill in the art, other drawings may also be obtained from these drawings without creative efforts.

FIG. 1 is a flowchart of a method for evaluating estimation accuracy of energy consumption per ton in distillation processes provided by the present disclosure.

FIG. 2 is a diagram of an accuracy evaluation result PGₙ obtained by a method for evaluating estimation accuracy of energy consumption per ton in distillation processes provided by the present disclosure and an RMSE simulation result of an estimation error (estimated value minus true value) of energy consumption per ton.

FIG. 3 is a schematic diagram of a system for evaluating estimation accuracy of energy consumption per ton in distillation processes provided by the present disclosure.

The reference numerals in the accompanying drawings are described as follows: 10. Model building module; 20. Energy consumption estimation module; 30. Estimation accuracy calculation module; and 40. Estimation accuracy evaluation module.

### DETAILED DESCRIPTION

In order to make the objectives, technical solutions and advantages of the present disclosure clearer, the embodiments of the present disclosure will be described in further detail below in conjunction with the accompanying drawings.

### Example 1

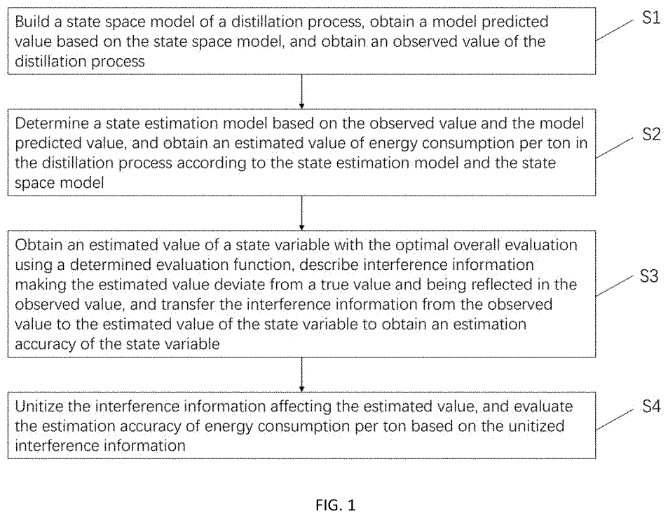

As shown in FIG. 1, the present example provides a method for evaluating estimation accuracy of energy consumption per ton in distillation processes, which includes the following steps:

S1: a state space model of a distillation process was built, a model predicted value was obtained based on the state space model, and an observed value of the distillation process was obtained;

S2: a state estimation model was determined based on the observed value and the model predicted value, and an estimated value of energy consumption per ton in the distillation process was obtained according to the state estimation model and the state space model;

S3: an estimated value of a state variable with the optimal overall evaluation was obtained using a determined evaluation function, interference information making the estimated value deviate from a true value was extracted from the observed value, and the interference information was transferred from the observed value to the estimated value of the state variable to obtain an estimation accuracy of the state variable; and

S4: the interference information affecting the estimated value was unitized, and the estimation accuracy of energy consumption per ton was evaluated based on the unitized interference information.

The present disclosure may well reflect the deviation between the estimated value and the true value without the true value, and evaluate the same object using different estimation methods under the same architecture, so that the evaluation results may cross different estimation methods and still have practicality, and also comparison of the results of evaluation methods of estimation accuracy of energy consumption per ton has practical significance.

In step S1, a method for building the state space model of the distillation process included:

firstly, for a material balance problem, a high-order model equation was built for the distillation process, a model with a five-dimensional structure was used, parameters of the distillation process model were changeable within a specific interval, and the concrete model form was:

xₙ=Aₙxₙ₋₁+Eₙuₙ+Bₙwₙ

yₙ=Cₙxₙ+vₙ

where xₙ=[xₙ¹, xₙ², xₙ³, xₙ⁴, xₙ⁵]^{T} is a state vector of a higher-order model of the distillation process; n is the time; xₙ¹ is the mole coefficient of low-density material components at the top in a distillation column; xₙ⁵ is the mole coefficient of low-density material components at the bottom in the distillation column; generally, low-density materials mainly include gas phase components in a crude oil fractionation process, e.g., gasoline, kerosene and diesel oil; oppositely, high-density materials mainly include liquid phase components in a crude oil separation process, e.g., heavy oil, while the gas phase components and liquid phase components in the distillation column are mixed; therefore, xₙ¹ is the mole coefficient of gas phase components in a crude oil mixture at the top in the distillation column, and xₙ⁵ is the mole coefficient of gas phase components in the crude oil mixture at the bottom in the distillation column; xₙ², xₙ³, xₙ⁴ are state variables used in estimation of energy consumption per ton, e.g., temperature, pressure, and reflux ratio; uₙ is a controlled variable of a distillation column system, e.g., temperature, and feed valve opening; in the present example, uₙ=0, which indicates that there is no control input throughout the operation of the distillation column system (previous studies have shown that the control input in state estimation has no effect on the estimation result, so the controlled variable in the present example was set to zero); wₙ is input disturbance of the distillation column; vₙ is sensor disturbance in the distillation column; and calculation forms of parameters Aₙ, Bₙ and Cₙ of the distillation column model are:

$${A}_{n} = [ \begin{matrix}- 2.9 & 0.3 & 0 & 0 & 0 \\ 0.9 & - 1.2 & 0.9 & 0 & 1.1 \\ 2.4 & 1.5 & - 4.9 & 12.4 & 3.2 \\ 0 & 0 & 5.1 & 11 & 1.1 \\ 0 & 0 & 0 & 2.3 & - 3.9\end{matrix} ]$$

$${B}_{n} = {[ \begin{matrix}0 & 0 & 1.6 & 0 & 0 \\ 0 & - 0.01 & 0.02 & 0.03 & 0\end{matrix} ]}^{T}$$

$${C}_{n} = {I}_{1 \times 5} ( I is a unit matrix ) .$$

In step S2, the state estimation model was determined based on the observed value and the model predicted value as follows:

\hat{x}ₙ=\hat{x}ₙ⁻+Kₙ(yₙ−Cₙ\hat{x}ₙ⁻),

where n is the time, \hat{x}ₙ⁻ is the model predicted value, yₙ is the observed value, \dot{x}ₙ is an estimated value of a state variable, and Kₙ is an estimated gain.

Preferably, an unbiased state estimation model was used as the state estimation model in the present example, that is, \dot{x}ₙ was converted into x̅ₙ, and the following unbiased state estimation model was built:

x̅ₙ=x̅ₙ⁻+K̅ₙ(yₙ−Cₙx̅ₙ⁻),

where n is the time, x̅ₙ⁻ is the model predicted value, yₙ is the observed value, x̅ₙ is an unbiased estimated value, and K̅ₙ is an unbiased estimated gain, x̅ₙ⁻=Aₙx̅ₙ₋₁.

Refer to the introduction in “Shmaliy, Y. S., Zhao, S., & Ahn, C. K. (2017). Unbiased finite impulse response filtering: an iterative alternative to kalman filtering ignoring noise and initial conditions. IEEE Control Systems Magazine, 37(5), 70-89.” for detailed introduction of the above unbiased state estimation model.

The unbiased state estimation model calculated the operation state estimation as follows:

State equations with a time window N m=n−N+1 were collected as follows:

$$\begin{matrix}\begin{matrix}\begin{matrix}\begin{matrix}\begin{matrix}{x}_{n} = {A}_{n} {x}_{n - 1} + {E}_{n} {u}_{n} + {B}_{n} {w}_{n} \\ {x}_{n - 1} = {A}_{n - 1} {x}_{n - 2} + {E}_{n - 1} {u}_{n - 1} + {B}_{n - 1} {w}_{n - 1}\end{matrix} \\ ⋮\end{matrix} \\ {x}_{m + 2} = {A}_{m + 2} {x}_{m + 1} + {E}_{m + 2} {u}_{m + 2} + {B}_{m + 2} {w}_{m + 2}\end{matrix} \\ {x}_{m + 1} = {A}_{m + 1} {x}_{m} + {E}_{m + 1} {u}_{m + 1} + {B}_{m + 1} {w}_{m + 1}\end{matrix} \\ {x}_{m} = {x}_{m} + {E}_{m} {u}_{m} + {B}_{m} {w}_{m}\end{matrix}$$

where m represents the initial time, n represents the current time, and N represents the length of a time window.

The above equations were combined to obtain an extended state equation (I is a unit matrix):

X_{m,n}=A_{m,n}xₘ+S_{m,n}U_{m,n}+D_{m,n}W_{m,n},

where X_{m,n}=[xₘ^{T}, xₘ₊₁^{T}, . . . , xₙ^{T}]^{T}, U_{m,n}=[uₘ^{T}, uₘ₊₁^{T}, . . . , uₙ^{T}]^{T}, W_{m,n}=[wₘ^{T}, wₘ₊₁^{T}, . . . , wₙ^{T}]^{T} and A_{m,n}=[I, Aₘ₊₁^{T}, . . . , (Aₙ₋₁^{m+1})^{T}, (Aₙ^{m+1})^{T}]^{T}

$${S}_{m , n} = [ \begin{matrix}{E}_{m} & 0 & … & 0 & 0 \\ {A}_{m + 1} {E}_{m} & {E}_{m + 1} & … & 0 & 0 \\ ⋮ & ⋮ & ⋱ & ⋮ & ⋮ \\ {A}_{n - 1}^{m + 1} {E}_{m} & {A}_{n - 1}^{m + 2} {E}_{m + !} & … & {E}_{n - 1} & 0 \\ {A}_{n}^{m + 1} {E}_{m} & {A}_{n}^{m + 2} {E}_{m + !} & … & 0 & {E}_{m}\end{matrix} ] ,$$

$${D}_{m , n} = [ \begin{matrix}{B}_{m} & 0 & … & 0 & 0 \\ {A}_{m + 1} {B}_{m} & {B}_{m + 1} & … & 0 & 0 \\ ⋮ & ⋮ & ⋱ & ⋮ & ⋮ \\ {A}_{n - 1}^{m + 1} {B}_{m} & {A}_{n - 1}^{m + 2} {B}_{m + !} & … & {B}_{n - 1} & 0 \\ {A}_{n}^{m + 1} {B}_{m} & {A}_{n}^{m + 2} {B}_{m + !} & … & 0 & {B}_{m}\end{matrix} ]$$

$${A}_{r}^{g} = \{ \begin{matrix}\begin{matrix}{A}_{r} {A}_{r - 1} … {A}_{g} , g < r + 1 \\ I , g = r + 1\end{matrix} \\ 0 , g > r + 1\end{matrix} .$$

Observation equations with a time window N m=n−N+1 were collected as follows:

$$\begin{matrix}\begin{matrix}\begin{matrix}{y}_{n} = {C}_{n} {x}_{n} + {v}_{n} \\ {y}_{n - 1} = {C}_{n - 1} {x}_{n - 1} + {v}_{n - 1}\end{matrix} \\ ⋮\end{matrix} \\ {y}_{m} = {C}_{m} {x}_{m} + {v}_{m}\end{matrix} .$$

The above equations were combined to obtain an extended observation equation:

Y_{m,n}=H̅_{m,n}xₘ+L_{m,n}U_{m,n}+G_{m,n}W_{m,n}+V_{m,n},

where Y_{m,n}=[yₘ^{T}, yₘ₊₁^{T}, . . . , yₙ^{T}]^{T}, V_{m,n}=[vₘ^{T}, vₘ₊₁^{T}, . . . , vₙ^{T}]^{T}, H̅_{m,n}=C̅_{m,n}A_{m,n}, L_{m,n}=C̅_{m,n}S_{m,n}, G_{m,n}=C̅_{m,n}D_{m,n} and

$${\overline{C}}_{m , n} = [ \begin{matrix}{C}_{m} & 0 & … & 0 \\ 0 & {C}_{m + 1} & … & 0 \\ ⋮ & ⋮ & ⋱ & ⋮ \\ 0 & 0 & … & {C}_{m}\end{matrix} ] .$$

The following algorithm was used for iteration from the unbiased initial iteration time l=s s=n−N+z (z is the state dimension) to l=n to obtain an unbiased estimated value x̅ₙ and an unbiased gain K̅ₙ (the value obtained by iteration to time l=n is the finally desired value). In the present application, z=5.

x̅ₗ⁻=Aₗ₋₁x̅ₗ₋₁+Eₗuₗ

Gₗ=[Cₗ^{T}Cₗ+(AₗGₗ₋₁Aₗ^{T})⁻¹]⁻¹

K̅ₗ=GₗGₗ^{T}

x̅ₗ=x̅ₗ⁻+K̅ₗ(yₗ−Cₗx̅ₗ⁻)

where at the initial value l=s, the calculation formulas were as follows:

Gₛ=(H_{m,s}^{T}H_{m,s})⁻¹

x̅ₓ=GₛH_{m,s}^{T}(Y_{m,s}−L_{m,s}U_{m,s})+S_{m,s}^{(z)}U_{m,s}

where z is the state dimension,

$${S}_{m , s}^{( z )} = {\underbrace{[ {A}_{s}^{m + 1} {E}_{m} , {A}_{s}^{m + 2} {E}_{m + 1} , … , {A}_{s} {E}_{s - 1} , {E}_{s} ]}}_{z}$$

According to the above algorithm process, finally the unbiased estimated value x̅ₙ and the unbiased gain K̅ₙ at time n were obtained and saved for use.

An estimated value of energy consumption per ton was obtained based on the estimated value of the state variable, by a calculation formula:

Ēₙ=f(x̅ₙ)=1.25[S₁x̅ₙ¹−S₂x̅ₙ⁵]+264.5, where S₁=120 ,and S₂=176.

In step S3, the evaluation function was determined as

F(x̅ₙ⁻, yₙ)=[K̅ₙ(yₙ−Cₙx̅ₙ⁻)]^{T}[K̅ₙ(yₙ−Cₙx̅ₙ⁻)], then the overall evaluation function was

$${\overline{x}}_{n} = arg {min}_{{x}_{n}} \frac{1}{T} {\sum }_{i = 1}^{T} F ( {\overline{x}}_{n}^{-} , {y}_{n} ) . ,$$

where T is the duration from the initial time to the current time.

In step S3, a method for extracting the interference information making the estimated value deviate from the true value from the observed value, and transferring the interference information from the observed value to the estimated value of the state variable to obtain the estimation accuracy of the state variable includes:

The interference information making the estimated value deviate from the true value and being reflected in the observed value was represented as yₙ^{δ}, where yₙ^{δ} [symbol] yₙ+δ, and δ represents any unknown vector with the same dimension as the observed value.

The interference information was transferred from the observed value to the estimated value of the state variable by the following formula:

$${\dot{x}}_{n} ( ε , δ ) = {arg min}_{x} {\sum }_{i = 0}^{n} {F}_{n} ( {\dot{x}}_{n}^{-} , {y}_{n} ) + ε [ F ( {\dot{x}}_{n}^{-} , {y}_{n}^{δ} ) - F ( {\dot{x}}_{n}^{-} , {y}_{n} ) ]$$

where ε is a minimum and scalar, and \dot{x}ₙ(ε, δ) represents the estimated value obtained in the case of yₙ^{δ}.

The estimation accuracy \dot{x}ₙ(ε, δ)−\dot{x}ₙ=Δ\dot{x}ₙ of the state variable was obtained based on the formula, where Δ\dot{x}ₙ is the deviation of the estimated value from the optimal estimated value.

The partial derivative of \dot{x}ₙ(ε, δ) in the directions ε was calculated to obtain a unitized value of the interference information affecting the estimated value:

$${{{\frac{{\dot{x}}_{n} ( ε , δ )}{d ε} \vert}_{ε = 0} n = \frac{d [ {arg min}_{x} {\sum }_{i = 0}^{n} F ( {x}_{i} , {y}_{i} ) ]}{d ε} \vert}_{ε = 0} + \frac{d ε [ F ( {\dot{x}}_{n} , {y}_{n}^{δ} ) - F ( {x}_{n} , {y}_{n} ) ]}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) )$$

where

$${ℋ}_{n} = \frac{1}{{T}_{1}} {Σ}_{i = 1}^{{T}_{1}} {∇}_{{\dot{x}}_{n - i + 1}}^{2} F ( {\dot{x}}_{n - i + 1} , {y}_{n - i + 1}^{δ} ) .$$

When ∥δ∥→0, the unitized value of the interference information affecting the estimated value was simplified as:

$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ .$$

The estimation accuracy of the state variable, the simplified unitized value of the interference information affecting the estimated value, and Euler formula were used to obtain:

$${\dot{x}}_{n} ( ε , δ ) - {\dot{x}}_{n} \approx - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ$$

In step S4, a method for evaluating the estimation accuracy of energy consumption per ton based on the unitized interference information includes:

The partial derivative of F(\dot{x}ₙ(ε, δ), yₙ^{δ}) in the direction δ was calculated to obtain and unitize the interference information affecting the estimated value under the vision of the evaluation function, and the unitized value was defined as an influence function Lₙ with the specific form as follows:

Lₙ^{T} [symbol] ∇_{δ}F(\dot{x}ₙ(ε, δ), yₙ^{δ})^{T}|_{δ=0}.

The influence function Lₙ was simplified, and a result of \dot{x}ₙ(ε, δ) was substituted into the simplified influence function Lₙ by using the derivation chain rule to obtain:

$$\begin{matrix}{{L}_{n}^{T} {=}^{△} {∇}_{δ} {F ( {\dot{x}}_{n} ( ε , δ ) , {y}_{n}^{δ} )}^{T} \vert}_{δ = 0} \\ {= {∇}_{{\dot{x}}_{n}} {F ( {\dot{x}}_{n} , {y}_{n}^{δ} )}^{T} \frac{d {\dot{x}}_{n} ( ε , δ )}{d δ} \vert}_{δ = 0} \\ = - {∇}_{{\dot{x}}_{n}} {F ( {\dot{x}}_{n} , {y}_{n}^{δ} )}^{T} {ℋ}_{n}^{- 1} ( {∇}_{{y}_{n}^{δ}} {∇}_{{\dot{x}}_{n}} F ( {\dot{x}}_{n} , {y}_{n}^{δ} ) )\end{matrix}$$

where ∇_{\dot{x}}_{ₙ}F(\dot{x}ₙ, yₙ^{δ}) is the first-order derivative of F(\dot{x}ₙ, yₙ^{δ}) in the direction \dot{x}ₙ, and ∇_{y}_{ₙ}_{^{δ}}∇_{\dot{x}}_{ₙ}F(\dot{x}ₙ, yₙ^{δ}) is the first-order derivative of ∇_{\dot{x}}_{ₙ}F(\dot{x}ₙ, yₙ^{δ}) in the direction yₙ^{δ}.

An evaluation result PGₙ=fₙ(Lⁱₙ) of the estimation accuracy of energy consumption per ton was obtained based on a solution formula of the estimation accuracy of the state variable, where PGₙ represents the evaluation result of energy consumption at time n, and Lⁱₙ represents column i in row i of Lₙ^{T}.

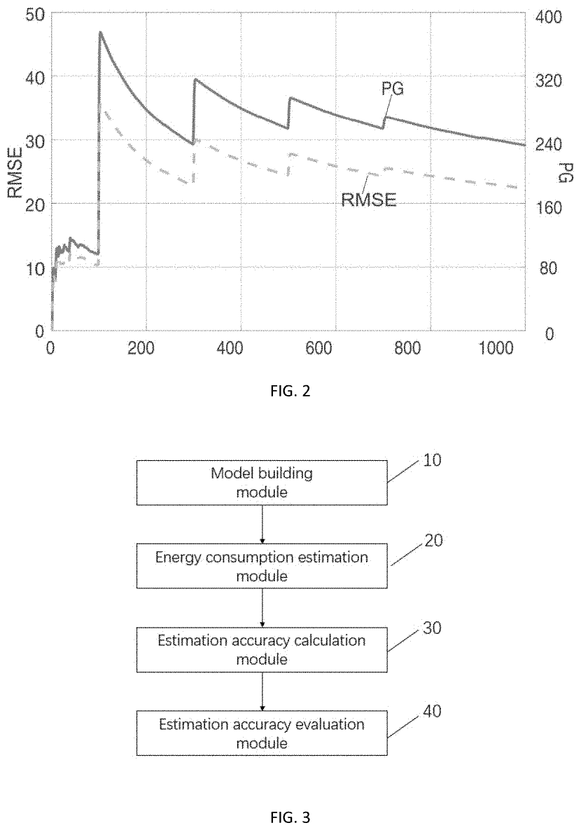

So far, the evaluation was completed. The evaluation result PGₙ of the estimation accuracy of energy consumption per ton obtained based on the above method and an RMSE simulation result of an estimation error (estimated value minus true value) of energy consumption per ton are shown in FIG. 2, where the solid line represents the evaluation result of the estimation accuracy of energy consumption per ton obtained by the method of the present application, and the dotted line represents the actual RMSE simulation result of the estimation error of energy consumption per ton (since the true value of energy consumption per ton cannot be obtained, the true value is obtained by simulation in the present application, and then the RMSE simulation result of the estimation error of energy consumption per ton is obtained). It can be seen that by the method of the present application, the evaluation result of the estimation accuracy of the estimated value of energy consumption per ton obtained by the existing energy consumption per ton estimation method is consistent with change of an estimation error curve of actual energy consumption per ton. It can be seen that the method of the present application can accurately evaluate the estimation accuracy of energy consumption without the true value and the optimal estimated value of energy consumption.

### EXAMPLE 2

As shown in FIG. 3, a system for evaluating estimation accuracy of energy consumption per ton in distillation processes disclosed in Example 2 of the present disclosure is introduced below. The system for evaluating estimation accuracy of energy consumption per ton in distillation processes described in the present example and the method for evaluating estimation accuracy of energy consumption per ton in distillation processes described in Example 1 may be referred to each other.

The system for evaluating estimation accuracy of energy consumption per ton in distillation processes disclosed by Example 2 includes:

a model building module 10, the model building module 10 is configured to build a state space model of a distillation process, obtain a model predicted value based on the state space model, and obtain an observed value of the distillation process;

an energy consumption estimation module 20, the energy consumption estimation module 20 is configured to determine a state estimation model based on the observed value and the model predicted value, and obtain an estimated value of energy consumption per ton in the distillation process according to the state estimation model and the state space model;

an estimation accuracy calculation module 30, the estimation accuracy calculation module 30 is configured to obtain an estimated value of a state variable with the optimal overall evaluation using a determined evaluation function, describe interference information making the estimated value deviate from a true value and being reflected in the observed value, and transfer the interference information from the observed value to the estimated value of the state variable to obtain an estimation accuracy of the state variable; and

an estimation accuracy evaluation module 40, the estimation accuracy evaluation module 40 is configured to unitize the interference information affecting the estimated value, and evaluate the estimation accuracy of energy consumption per ton based on the unitized interference information.

The estimation accuracy evaluation module includes an interference information quantization unit, and the interference information quantization unit is configured to unitize the interference information affecting the estimated value, by a method including:

The partial derivative of \dot{x}ₙ(ε, δ) in the direction ε was calculated to obtain a unitized value of the interference information affecting the estimated value:

$${{{\frac{{\dot{x}}_{n} ( ε , δ )}{d ε} \vert}_{ε = 0} n = \frac{d [ {arg min}_{x} {{\sum }_{i = 0}}^{n} F ( {x}_{i} , {y}_{i} ) ]}{d ε} \vert}_{ε = 0} + \frac{d ε [ F ( {\dot{x}}_{n} , {y}_{n}^{δ} ) - F ( {x}_{n} , {y}_{n} ) ]}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) )$$

where

$${ℋ}_{n} = \frac{1}{{T}_{1}} {\sum }_{i = 1}^{{T}_{1}} {∇}_{{\dot{x}}_{n - i + 1}}^{2} F ( {\dot{x}}_{n - i + 1} , {y}_{n - i + 1}^{δ} ) .$$

When ∥δ∥→0, the unitized value of the interference information affecting the estimated value was simplified as:

$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ .$$

The estimation accuracy of the state variable, the simplified unitized value of the interference information affecting the estimated value, and Euler formula were used to obtain:

$$\begin{matrix}{\dot{x}}_{n} ( ε , δ ) - {\dot{x}}_{n} \approx - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \\ \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ\end{matrix} .$$

The estimation accuracy evaluation module includes an estimation accuracy of energy consumption per ton evaluation unit, and the estimation accuracy of energy consumption per ton evaluation unit is configured to evaluate the estimation accuracy of energy consumption per ton based on the unitized interference information, by a method including:

The partial derivative of F(\dot{x}ₙ(ε, δ), yₙ^{δ}) in the direction δ was calculated to obtain and unitize the interference information affecting the estimated value under the vision of the evaluation function, and the unitized value was defined as an influence function Lₙ with the specific form as follows:

Lₙ^{T} [symbol] ∇_{δ}F(\dot{x}ₙ(ε, δ), yₙ^{δ})^{T}|_{δ=0}.

The influence function Lₙ was simplified, and a result of \dot{x}ₙ(ε, δ) was substituted into the simplified influence function Lₙ by using the derivation chain rule to obtain:

$$\begin{matrix}{{L}_{n}^{T} {=}^{△} {∇}_{δ} {F ( {\dot{x}}_{n} ( ε , δ ) , {y}_{n}^{δ} )}^{T} \vert}_{δ = 0} \\ {= {∇}_{{\dot{x}}_{n}} {F ( {\dot{x}}_{n} , {y}_{n}^{δ} )}^{T} \frac{d {\dot{x}}_{n} ( ε , δ )}{d δ} \vert}_{δ = 0} \\ = - {∇}_{{\dot{x}}_{n}} {F ( {\dot{x}}_{n} , {y}_{n}^{δ} )}^{T} {ℋ}_{n}^{- 1} ( {∇}_{{y}_{n}^{δ}} {∇}_{{\dot{x}}_{n}} F ( {\dot{x}}_{n} , {y}_{n}^{δ} ) )\end{matrix}$$

where ∇_{\dot{x}}_{ₙ}F(\dot{x}ₙ, yₙ^{δ}) is the first-order derivative of F(\dot{x}ₙ, yₙ^{δ}) in the direction \dot{x}ₙ, and ∇_{y}_{ₙ}_{^{δ}}∇_{\dot{x}}_{ₙ}F(\dot{x}ₙ, yₙ^{δ}) is the first-order derivative of ∇_{\dot{x}}_{ₙ}F(\dot{x}ₙ, yₙ^{δ}) in the direction yₙ^{δ}.

An evaluation result PGₙ=fₙ(Lⁱₙ) of the estimation accuracy of energy consumption per ton was obtained based on a solution formula of the estimation accuracy of the state variable, where PGₙ represents the evaluation result of energy consumption at time n, and Lⁱₙ represents column i in row i of Lₙ^{T}.

The system for evaluating estimation accuracy of energy consumption per ton in distillation processes of the present example is used for implementing the aforementioned method for evaluating estimation accuracy of energy consumption per ton in distillation processes. Therefore, the examples of the method for evaluating estimation accuracy of energy consumption per ton in distillation processes described above may be referred to for the specific embodiments of the system, and the description of the corresponding examples may be referred to for the specific embodiments, which will not be introduced here.

In addition, since the system for evaluating estimation accuracy of energy consumption per ton in distillation processes of the present example is used for implementing the aforementioned method for evaluating estimation accuracy of energy consumption per ton in distillation processes, the effect of the system corresponds to that of the above method, and will not be repeated here.

Those skilled in the art should understand that the examples of the present application may be provided as methods, systems, or computer program products. Therefore, the present application may take the form of a complete hardware example, a complete software example, or an example combining software and hardware aspects. Moreover, the present application may take the form of a computer program product implemented on one or more computer usable storage media (including but not limited to disk memory, CD-ROM, optical memory, etc.) containing computer usable program codes.

The present application is described with reference to the flowcharts and/or block diagrams of the method, equipment (system), and computer program product according to the examples of the present application. It should be understood that each flow and/or block in the flowcharts and/or block diagrams, and the combination of flows and/or blocks in the flowcharts and/or block diagrams may be implemented by computer program instructions. These computer program instructions may be provided to a processor of a general purpose computer, a special purpose computer, an embedded processor, or other programmable data processing equipment to generate a machine, such that the instructions executed by the processor of the computer or other programmable data processing equipment generate a device for implementing a function and/or functions as specified in one or more flows in the flowchart and/or one or more blocks in the block diagram.

These computer program instructions may also be stored in a computer-readable memory that can guide the computer or other programmable data processing equipment to work in a specific way, such that the instructions stored in the computer-readable memory generate a manufactured product including an instruction device, and the instruction device implements a function and/or functions as specified in one or more flows in the flowchart and/or one or more blocks in the block diagram.

These computer program instructions may also be loaded onto the computer or other programmable data processing equipment, such that a series of operating steps are executed on the computer or other programmable equipment to generate computer-implemented processing, and instructions executed on the computer or other programmable equipment provide steps for implementing a function and/orfunctions as specified in one or more flows in the flowchart and/or one or more blocks in the block diagram.

Obviously, the above examples are only examples for clear explanation, not the limitation of embodiments. For those of ordinary skill in the art, other changes or variations in different forms may be made on the basis of the above description. It is unnecessary and impossible to enumerate all embodiments here. The obvious changes or variations arising from the above description are still within the protection scope of the present disclosure.

What is claimed is:

1. A method and system for evaluating estimation accuracy of energy consumption per ton in distillation processes, wherein the method comprises:
S1: building a state space model of a distillation process, obtaining a model predicted value based on the state space model, and obtaining an observed value of the distillation process, a method for building the state space model of the distillation process comprising:
for a material balance problem, building a high-order model equation for the distillation process, a model with a five-dimensional structure being used, parameters of the distillation process model being changeable within a specific interval, and the concrete model form being:
xₙ=Aₙxₙ₋₁+Eₙuₙ+Bₙwₙ
yₙ=Cₙxₙ+vₙ
wherein xₙ=[xₙ¹, xₙ², xₙ³, xₙ⁴, xₙ⁵]^{T} is a state vector of a higher-order model of the distillation process; n is the time; xₙ¹ is the mole coefficient of low-density material components at the top in a distillation column; xₙ⁵ is the mole coefficient of low-density material components at the bottom in the distillation column; xₙ², xₙ³, xₙ⁴ are state variables used in estimation of energy consumption per ton; uₙ is a controlled variable of a distillation column system; wₙ is input disturbance of the distillation column; vₙ is sensor disturbance in the distillation column; calculation forms of parameters Aₙ, Bₙ and Cₙ of the distillation column model are:
$${A}_{n} = [ \begin{matrix}- 2.9 & 0.3 & 0 & 0 & 0 \\ 0.9 & - 1.2 & 0.9 & 0 & 1.1 \\ 2.4 & 1.5 & - 4.9 & 12.4 & 3.2 \\ 0 & 0 & 5.1 & 11 & 1.1 \\ 0 & 0 & 0 & 2.3 & - 3.9\end{matrix} ]$$
$${B}_{n} = {[ \begin{matrix}0 & 0 & 1.6 & 0 & 0 \\ 0 & - 0.01 & 0.02 & 0.03 & 0\end{matrix} ]}^{T}$$
$${C}_{n} = {I}_{1 \times 5} , I is a unit matrix ;$$
S2: determining a state estimation model based on the observed value and the model predicted value as follows:
\hat{x}ₙ=\hat{x}ₙ⁻+Kₙ(yₙ−Cₙ\hat{x}ₙ⁻)
wherein n is the time, \hat{x}ₙ⁻ is the model predicted value, yₙ is the observed value, \dot{x}ₙ is an estimated value of a state variable, and Kₙ is an estimated gain; obtaining an estimated value of energy consumption per ton in the distillation process according to the state estimation model and the state space model, comprising:
conducting state estimation at a certain time according to the state estimation model and the state space model to obtain a state estimated gain and an estimated value of the state variable at a current time; and
obtaining an estimated value of energy consumption per ton based on the estimated value of the state variable, a calculation formula being: Ēₙ=f(x̅ₙ)=1.25[S₁x̅ₙ¹−S₂x̅ₙ⁵]+264.5;
S3: obtaining an estimated value of the state variable with the optimal overall evaluation using a determined evaluation function, comprising: determining a mathematical expression of the evaluation function to be F(\dot{x}ₙ⁻, yₙ), and obtaining the estimated value
$${\dot{x}}_{n} = arg {min}_{{x}_{n}} \frac{1}{T} {\sum }_{i = 1}^{T} F ( {\dot{x}}_{n}^{-} , {y}_{n} )$$
of the state variable with the optimal overall evaluation by the evaluation function, wherein T is the duration from an initial time to the current time;
describing interference information making the estimated value deviate from a true value and being reflected in the observed value, and transferring the interference information from the observed value to the estimated value of the state variable to obtain an estimation accuracy of the state variable, comprising:
representing the interference information making the estimated value deviate from the true value and being reflected in the observed value as yₙ^{δ}, wherein yₙ^{δ} [symbol] yₙ+δ, and δ represents a vector with the same dimension as the observed value;
transferring the interference information from the observed value to the estimated value of the state variable by the following formula:
$${\dot{x}}_{n} ( ε , δ ) = {arg min}_{x} {\sum }_{i = 0}^{n} {F}_{n} ( {\dot{x}}_{n}^{-} , {y}_{n} ) + ε [ F ( {\dot{x}}_{n}^{-} , {y}_{n}^{δ} ) - F ( {\dot{x}}_{n}^{-} , {y}_{n} ) ]$$
wherein ε is a minimum and scalar, and \dot{x}ₙ(ε, δ) represents the estimated value obtained in the case of yₙ^{δ}; and
obtaining the estimation accuracy \dot{x}ₙ(ε, δ)−\dot{x}ₙ=Δ\dot{x}ₙ of the state variable based on the formula, wherein Δ\dot{x}ₙ is the deviation of the estimated value from the optimal estimated value; and
S4: unitizing the interference information affecting the estimated value, comprising:
calculating the partial derivative of \dot{x}ₙ(ε, δ) in the direction ε to obtain a unitized value of the interference information affecting the estimated value:
$${{{\frac{d {\dot{x}}_{n} ( ε , δ )}{d ε} \vert}_{ε = 0} = \frac{d [ {arg min}_{{x}_{n}} {\sum }_{i = 0}^{n} F ( {x}_{i} , {y}_{i} ) ]}{d ε} \vert}_{ε = 0} + \frac{d ε [ F ( {\dot{x}}_{n} , {y}_{n}^{δ} ) - F ( {x}_{n} , {y}_{n} ) ]}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) )$$
wherein
$${ℋ}_{n} = \frac{1}{{T}_{1}} {\sum }_{i = 1}^{{T}_{1}} {∇}_{{\dot{x}}_{n - i + 1}}^{2} F ( {\dot{x}}_{n - i + 1} , {y}_{n - i + 1}^{δ} ) ;$$
when ∥δ∥→0, simplifying the unitized value of the interference information affecting the estimated value as:
$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ ;$$
and using the estimation accuracy of the state variable, the simplified unitized value of the interference information affecting the estimated value, and Euler formula to obtain:
$$\begin{matrix}{\dot{x}}_{n} ( ε , δ ) - {\dot{x}}_{n} \approx - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \\ \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ\end{matrix}$$
evaluating the estimation accuracy of energy consumption per ton based on the unitized interference information, comprising:
calculating the partial derivative of F(\dot{x}ₙ(ε, δ), yₙ^{δ}) in the direction δ to obtain and unitize the interference information affecting the estimated value under the vision of the evaluation function, and defining the unitized value as an influence function Lₙ with the specific form as follows:
Lₙ^{T} [symbol] ∇_{δ}F(\dot{x}ₙ(ε, δ), yₙ^{δ})^{T}|_{δ=0};
simplifying the influence function Lₙ, and substituting a result of \dot{x}ₙ(ε, δ) into the simplified influence function Lₙ by using the derivation chain rule to obtain:
$$\begin{matrix}{{L}_{n}^{T} {=}^{△} {∇}_{δ} {F ( {\dot{x}}_{n} ( ε , δ ) , {y}_{n}^{δ} )}^{T} \vert}_{δ = 0} \\ {= {∇}_{{\dot{x}}_{n}} {F ( {\dot{x}}_{n} , {y}_{n}^{δ} )}^{T} \frac{d {\dot{x}}_{n} ( ε , δ )}{d δ} \vert}_{δ = 0} \\ = - {∇}_{{\dot{x}}_{n}} , {F ( {\dot{x}}_{n} , {y}_{n}^{δ} )}^{T} {ℋ}_{n}^{- 1} ( {∇}_{{y}_{n}^{δ}} , {∇}_{{\dot{x}}_{n}} F ( {\dot{x}}_{n} , {y}_{n}^{δ} ) )\end{matrix}$$
wherein ∇_{\dot{x}}_{ₙ}F(\dot{x}ₙ, yₙ^{δ}) is the first-order derivative of F(\dot{x}ₙ, yₙ^{δ}) in the direction \dot{x}ₙ, and ∇_{y}_{ₙ}_{^{δ}}∇_{\dot{x}}_{ₙ}F(\dot{x}ₙ, yₙ^{δ}) is the first-order derivative of ∇_{\dot{x}}_{ₙ}F(\dot{x}ₙ, yₙ^{δ}) in the direction yₙ^{δ}; and
obtaining an evaluation result PGₙ=fₙ(Lⁱₙ) of the estimation accuracy of energy consumption per ton based on a solution formula of the estimation accuracy of the state variable, wherein PGₙ represents the evaluation result of energy consumption at time n, and Lⁱₙ represents column i in row i of Lₙ^{T}.

2. A system for evaluating estimation accuracy of energy consumption per ton in distillation processes, comprising:
a model building module, the model building module being configured to build a state space model of a distillation process, obtain a model predicted value based on the state space model, and obtain an observed value of the distillation process, a method for building the state space model of the distillation process comprising:
for a material balance problem, building a high-order model equation for the distillation process, a model with a five-dimensional structure being used, parameters of the distillation process model being changeable within a specific interval, and the concrete model form being:
xₙ=Aₙxₙ₋₁+Eₙuₙ+Bₙwₙ
yₙ=Cₙxₙ+vₙ
wherein xₙ=[xₙ¹, xₙ², xₙ³, xₙ⁴, xₙ⁵]^{T} is a state vector of a higher-order model of the distillation process; n is the time; xₙ¹ is the mole coefficient of low-density material components at the top in a distillation column; xₙ⁵ is the mole coefficient of low-density material components at the bottom in the distillation column; xₙ², xₙ³, xₙ⁴ are state variables used in estimation of energy consumption per ton; uₙ is a controlled variable of a distillation column system; wₙ is input disturbance of the distillation column; vₙ is sensor disturbance in the distillation column; calculation forms of parameters Aₙ, Bₙ and Cₙ of the distillation column model are:
$${A}_{n} = [ \begin{matrix}- 2.9 & 0.3 & 0 & 0 & 0 \\ 0.9 & - 1.2 & 0.9 & 0 & 1.1 \\ 2.4 & 1.5 & - 4.9 & 12.4 & 3.2 \\ 0 & 0 & 5.1 & 11 & 1.1 \\ 0 & 0 & 0 & 2.3 & - 3.9\end{matrix} ] .$$
$${B}_{n} = {[ \begin{matrix}0 & 0 & 1.6 & 0 & 0 \\ 0 & - 0.01 & 0.02 & 0.03 & 0\end{matrix} ]}^{T}$$
$${C}_{n} = {I}_{1 \times 5} , I is a unit matrix ;$$
an energy consumption estimation module, the energy consumption estimation module being configured to determine a state estimation model based on the observed value and the model predicted value as follows:
\hat{x}ₙ=\hat{x}ₙ⁻+Kₙ(yₙ−Cₙ\hat{x}ₙ⁻)
wherein n is the time, \hat{x}ₙ⁻ is the model predicted value, yₙ is the observed value, \dot{x}ₙ is an estimated value of a state variable, and Kₙ is an estimated gain;
obtain an estimated value of energy consumption per ton in the distillation process according to the state estimation model and the state space model, comprising:
conducting state estimation at a certain time according to the state estimation model and the state space model to obtain a state estimated gain and an estimated value of the state variable at a current time; and
obtaining an estimated value of energy consumption per ton based on the estimated value of the state variable, a calculation formula being: Ēₙ=f(x̅ₙ)=1.25[S₁x̅ₙ¹−S₂x̅ₙ⁵]+264.5;
an estimation accuracy calculation module, the estimation accuracy calculation module being configured to obtain an estimated value of the state variable with the optimal overall evaluation using a determined evaluation function, comprising: determine a mathematical expression of the evaluation function to be F(\dot{x}ₙ⁻, yₙ), and obtain the estimated value
$${\dot{x}}_{n} = arg {min}_{{x}_{n}} \frac{1}{T} {\sum }_{i = 1}^{T} F ( {\dot{x}}_{n}^{-} , {y}_{n} )$$
of the state variable with the optimal overall evaluation by the evaluation function, wherein T is the duration from an initial time to the current time;
describe interference information making the estimated value deviate from a true value and being reflected in the observed value, and transfer the interference information from the observed value to the estimated value of the state variable to obtain an estimation accuracy of the state variable, comprising:
represent the interference information making the estimated value deviate from the true value and being reflected in the observed value as yₙ^{δ}, wherein yₙ^{δ} [symbol] yₙ+δ, and δ represents a vector with the same dimension as the observed value;
transfer the interference information from the observed value to the estimated value of the state variable by the following formula:
$${\dot{x}}_{n} ( ε , δ ) = {arg min}_{x} {\sum }_{i = 0}^{n} {F}_{n} ( {\dot{x}}_{n}^{-} , {y}_{n} ) + ε [ F ( {\dot{x}}_{n}^{-} , {y}_{n}^{δ} ) - F ( {\dot{x}}_{n}^{-} , {y}_{n} ) ]$$
wherein ε is a minimum and scalar, and \dot{x}ₙ(ε, δ) represents the estimated value obtained in the case of yₙ^{δ}; and
obtain the estimation accuracy \dot{x}ₙ(ε, δ)−\dot{x}ₙ=Δ\dot{x}ₙ of the state variable based on the formula, wherein Δ\dot{x}ₙ is the deviation of the estimated value from the optimal estimated value; and
an estimation accuracy evaluation module, the estimation accuracy evaluation module being configured to unitize the interference information affecting the estimated value, and evaluate the estimation accuracy of energy consumption per ton based on the unitized interference information, the estimation accuracy evaluation module comprising an interference information quantization unit, the interference information quantization unit being configured to unitize the interference information affecting the estimated value, by a method comprising:
calculating the partial derivative of \dot{x}ₙ(ε, δ) in the direction ε to obtain a unitized value of the interference information affecting the estimated value:
$${{{\frac{d {\dot{x}}_{n} ( ε , δ )}{d ε} \vert}_{ε = 0} = \frac{d [ {arg min}_{{x}_{n}} {\sum }_{i = 0}^{n} F ( {x}_{i} , {y}_{i} ) ]}{d ε} \vert}_{ε = 0} + \frac{d ε [ F ( {\dot{x}}_{n} , {y}_{n}^{δ} ) - F ( {x}_{n} , {y}_{n} ) ]}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) )$$
wherein
$${ℋ}_{n} = \frac{1}{{T}_{1}} {\sum }_{i = 1}^{{T}_{1}} {∇}_{{\dot{x}}_{n - i + 1}}^{2} F ( {\dot{x}}_{n - i + 1} , {y}_{n - i + 1}^{δ} ) ;$$
when ∥δ∥→0, simplifying the unitized value of the interference information affecting the estimated value as:
$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ ;$$
using the estimation accuracy of the state variable, the simplified unitized value of the interference information affecting the estimated value, and Euler formula to obtain:
$${\frac{{\dot{x}}_{n} ( ε , δ )}{d ε} \vert}_{ε = 0} = - {ℋ}_{n}^{- 1} ( {∇}_{{\dot{x}}_{n}} F ( {\dot{x}}_{n} , {y}_{n}^{δ} ) - {∇}_{{\dot{x}}_{n}} F ( {x}_{n} , {y}_{n} ) ) \approx - {ℋ}_{n}^{- 1} ( {∇}_{{y}_{n}^{δ}} {∇}_{{\dot{x}}_{n}} F ( {\dot{x}}_{n} , {y}_{n}^{δ} ) ) δ$$
the estimation accuracy evaluation module comprising an estimation accuracy of energy consumption per ton evaluation unit, the estimation accuracy of energy consumption per ton evaluation unit being configured to evaluate the estimation accuracy of energy consumption per ton based on the unitized interference information, by a method comprising:
calculating the partial derivative of F(\dot{x}ₙ(ε, δ), yₙ^{δ}) in the direction δ to obtain and unitize the interference information affecting the estimated value under the vision of the evaluation function, and defining the unitized value as an influence function Lₙ with the specific form as follows:
Lₙ^{T} [symbol] ∇_{δ}F(\dot{x}ₙ(ε, δ), yₙ^{δ})^{T}|_{δ=0};
simplifying the influence function Lₙ, and substituting a result of \dot{x}ₙ(ε, δ) into the simplified influence function Lₙ by using the derivation chain rule to obtain:
$$\begin{matrix}{{L}_{n}^{T} {=}^{△} {∇}_{δ} {F ( {\dot{x}}_{n} ( ε , δ ) , {y}_{n}^{δ} )}^{T} \vert}_{δ = 0} \\ {= {∇}_{{\dot{x}}_{n}} {F ( {\dot{x}}_{n} , {y}_{n}^{δ} )}^{T} \frac{d {\dot{x}}_{n} ( ε , δ )}{d δ} \vert}_{δ = 0} \\ = - {∇}_{{\dot{x}}_{n}} , {F ( {\dot{x}}_{n} , {y}_{n}^{δ} )}^{T} {ℋ}_{n}^{- 1} ( {∇}_{{y}_{n}^{δ}} , {∇}_{{\dot{x}}_{n}} F ( {\dot{x}}_{n} , {y}_{n}^{δ} ) )\end{matrix}$$
wherein ∇_{\dot{x}}_{ₙ}F(\dot{x}ₙ, yₙ^{δ}) is the first-order derivative of F(\dot{x}ₙ, yₙ^{δ}) in the direction \dot{x}ₙ, and ∇_{y}_{ₙ}_{^{δ}}∇_{\dot{x}}_{ₙ}F(\dot{x}ₙ, yₙ^{δ}) is the first-order derivative of ∇_{\dot{x}}_{ₙ}F(\dot{x}ₙ, yₙ^{δ}) in the direction yₙ^{δ}; and
obtaining an evaluation result PGₙ=fₙ(Lⁱₙ) of the estimation accuracy of energy consumption per ton based on a solution formula of the estimation accuracy of the state variable, wherein PGₙ represents the evaluation result of energy consumption at time n, and Lⁱₙ represents column i in row i of Lₙ^{T}.
